(19) United States
(12) Patent Application Publication
(10) Pub. No.: US 2003/0099307 A1
(43) Pub. Date: May 29, 2003

(54) Differential slicer circuit for data communication

(75) Inventor: Miaochen Wu, Acton, MA (US)

Correspondence Address: Leo R. Reynolds, Esq., HAMILTON, BROOK, SMITH & REYNOLDS, P.C., 530 Virginia Road, P.O. Box 9133, Concord, MA, 01742-9133, US

(73) Assignee: Narad Networks, Inc., Westford, MA

(21) Appl. No.: 10/008,364

(22) Filed: Nov. 13, 2001

(51) Int. Cl. H04L 25/06

(52) U.S. Cl. 375/317

(57) ABSTRACT

A differential slicer circuit includes a plurality of differential comparators and threshold voltages. Each differential comparator includes two matched amplifiers cross-coupled as a subtractor for a differential threshold signal dependent on the threshold voltages. The differential comparator outputs a differential output voltage dependent on the difference between an input differential signal and the differential threshold voltage.

### RELATED APPLICATIONS

This application is related to Attorney Docket No. 3070.1008-000 entitled “Frequency Acquisition and Locking Detection Circuit for Phase Lock Loop” by Miaochen Wu, et al., Attorney Docket No.: 3070.1009-000 entitled “Automatic Gain Control Circuit With Multiple Input Signals”, by Miaochen Wu, and Attorney Docket No.: 3070.1011-000 entitled “Slicer Circuit With Ping Pong Scheme For Data Communication”, by Dev Gupta, et al., filed on even date herewith. The entire teachings of the above applications are incorporated herein by reference.

### BACKGROUND OF THE INVENTION

A broadband modem typically transmits data at data rates greater than 10 Mbps over a coaxial cable. A cable modem can use Quadrature Amplitude Modulation (QAM) to obtain a high data rate. Quadrature Amplitude Modulation (QAM) is a method for doubling effective bandwidth by combining two Amplitude Modulated carriers in a single channel. Each of the two carriers in the channel has the same frequency but differs in phase by 90 degrees. One carrier is called the In-phase (I) signal and the other carrier is called the Quadrature (Q) signal. The receiver recovers the I and Q signals from the received QAM signal and extracts the data encoded on each signal. To extract the data, the analog I and Q signals are converted into a digital encoded signal.

A slicer circuit is typically used to convert data encoded on the I and Q signals into the digital encoded signal. The slicer circuit is a simplified version of an analog to digital converter which converts the I and Q signals based on threshold voltage levels. The peak to peak voltage (the magnitude) of the I and Q signals varies, thus the I and Q signals are first passed through an amplifier that outputs converted I and Q signals with a set magnitude. The magnitude of the converted I and Q signals is controlled by an Automatic Gain Control (AGC) circuit. The common mode voltage of the I and Q signals is not well defined and changes with changes in power supply voltages, temperature and semiconductor processes. As data is being received, the threshold voltage levels remain constant due to the AGC circuit but the common mode voltage can change. Any change in common mode voltage impacts the decision of the slicer circuit. To avoid errors in recovering the encoded data, requires controlling the common mode voltage. However, it is difficult to maintain a constant common mode voltage while the data is being recovered.

### SUMMARY OF THE INVENTION

A slicer circuit according to the principles of the present invention includes at least one differential comparator and a threshold voltage circuit which generates a plurality of differential threshold signals. The slicer circuit can include a plurality of differential comparators. The differential comparator includes a first differential amplifier and a second differential amplifier. The first and second differential amplifiers are cross-coupled to output a differential output signal. The differential output signal is dependent on a difference between one of the differential threshold signals coupled to the first differential amplifier and a differential input signal coupled to the second differential amplifier.

The first and second differential amplifiers are cross-coupled by coupling the collector of a first transistor to the collector of a third transistor and the collector of a second transistor to the collector of a fourth transistor. A non-inverting input of the first differential amplifier is coupled to the first transistor. An inverting input of the first differential amplifier is coupled to the second transistor. A non-inverting input of the second amplifier is coupled to the third transistor and an inverting input of the second differential amplifier is coupled to the fourth transistor.

The slicer circuit also includes two emitter followers. A first emitter follower is coupled to the first differential amplifier and a second emitter follower is coupled to the second differential amplifier. The differential output is coupled between the first emitter follower and the second emitter follower.

The transistors are bi-polar and operate in a linear region. In one embodiment, the differential input signal is 600 milli Volts peak to peak differentially and the differential threshold signals are 200 mV, −200 mV and 0V. In one embodiment, there are three differential comparators in the slicer circuit.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an embodiment of a network configuration of intelligent network elements for providing point-to-point data links between intelligent network elements in a broadband, bidirectional access system;

FIG. 2 is a block diagram of an embodiment of any one of the network elements shown in FIG. 1;

FIG. 3 is a block diagram of a receiver in any of the modems in the network element shown in FIG. 2;

FIG. 4A is a block diagram of a differential slicer circuit in the ADC stage shown in FIG. 3 according to the principles of the present invention;

FIG. 4B is a circuit diagram of the differential comparator circuit and bandgap reference circuit in the differential slicer circuit shown in FIG. 4A.

FIG. 5 illustrates an example of a differential input signal that is input to each of the differential comparators the slicer circuit shown in FIG. 4;

FIG. 6 is a circuit diagram of one of the differential comparators in the slicer shown in FIG. 4; and

FIG. 7 is a timing diagram illustrating the signals in the differential comparator shown in FIG. 4.

### DETAILED DESCRIPTION OF THE INVENTION

A description of preferred embodiments of the invention follows.

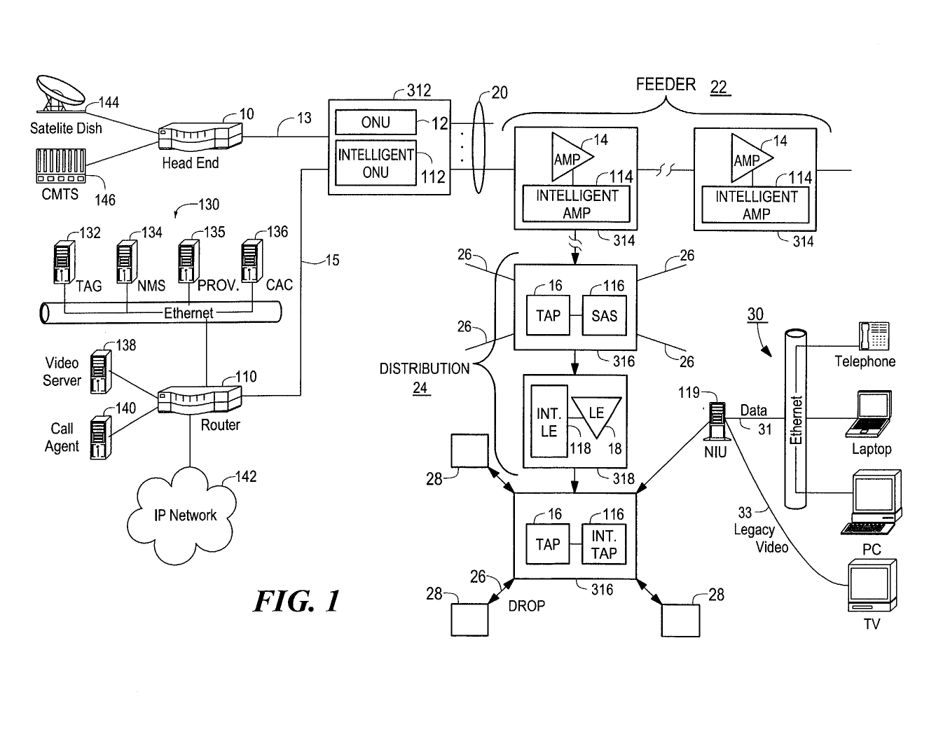

FIG. 1 illustrates an embodiment of a network configuration of intelligent network elements for providing point to point data links between intelligent network elements in a broadband, bidirectional access system. This network configuration is described in U.S. patent application Ser. No. 09/952,321 filed Sep. 13, 2001 entitled “Broadband System With Topology Discovery”, by Gautam Desai, et al, the entire teachings of which are incorporated herein by reference. The network configuration, also referred to herein as an Access Network, includes intelligent network elements each of which uses a physical layer technology that allows data connections to be carried over coax cable distribution facilities from every subscriber. In particular, point-to-point data links are established between the intelligent network elements over the coax cable plant. Signals are terminated at the intelligent network elements, switched and regenerated for transmission across upstream or downstream data links as needed to connect a home to the headend.

The intelligent network elements are interconnected using the existing cable television network such that the point-to-point data links are carried on the cable plant using bandwidth that resides above the standard upstream/downstream spectrum. For example, the bandwidth can reside at 1025 to 1125 MHZ (upstream) and 1300 to 1400 MHZ (downstream) or 100 Mbps upstream and downstream bandwidths can be provided in the spectrum 750 to 860 MHZ or duplexing channel spectrums can be allocated in the 777.5 MHz to 922.5 MHz regime for 100 Mb/s operation and in the 1 GHz to 2 GHz regime for 1 Gb/s operation.

The intelligent network elements include an intelligent optical network unit or node 112, intelligent trunk amplifier 114, intelligent tap or subscriber access switch (SAS) 116, intelligent line extender 118 and network interface unit (NW ) 119. A standard residential gateway or local area network 30 connected to the NIU 119 at the home is also shown. Note that the trunk amplifier 114 is also referred to herein as a distribution switch (DS). The configuration shown includes ONU assembly 312 Rev comprising standard ONU 12 and intelligent ONU 112 also referred to herein as an optical distribution switch (ODS). Likewise, trunk amplifier or DA assembly 314 includes conventional trunk amp 14 and intelligent trunk amp 114; cable tap assembly 316 includes standard tap 16 and subscriber access switch 116; and line extender assembly 318 includes standard line extender 18 and intelligent line extender 118.

The intelligent ONU or ODS is connected over line 15 to a router 110, which has connections to a server farm 130, a video server 138, a call agent 140 and IP network 142. The server farm 130 includes a Tag/Topology server 132, a network management system (NMS) server 134, a provisioning server 135 and a connection admission control (CAC) server 136, all coupled to an Ethernet bus which are described in U.S. patent application Ser. No. 09/952,321 filed Sep. 13, 2001 entitled “Broadband System With Topology Discovery”, by Gautam Desai, et al, the entire teachings of which are incorporated herein by reference.

A headend 10 is shown having connections to a satellite dish 144 and CMTS 146. To serve the legacy portion of the network, the headend 10 delivers a conventional amplitude modulated optical signal to the ONU 12. This signal includes the analog video and DOCSIS channels. The ONU performs an optical to electrical (O/E) conversion and sends radio frequency (RF) signals over feeder coax cables 20 to the trunk amplifiers or DAs 14. Each DA along the path amplifies these RF signals and distributes them over the distribution portion 24.

The present system includes intelligent network elements that can provide high bandwidth capacity to each home. In the Access Network of the present invention, each intelligent network element provides switching of data packets for data flow downstream and statistical multiplexing and priority queuing for data flow upstream. The legacy video and DOCSIS data signals can flow through transparently because the intelligent network elements use a part of the frequency spectrum of the coax cable that does not overlap with the spectrum being used for legacy services.

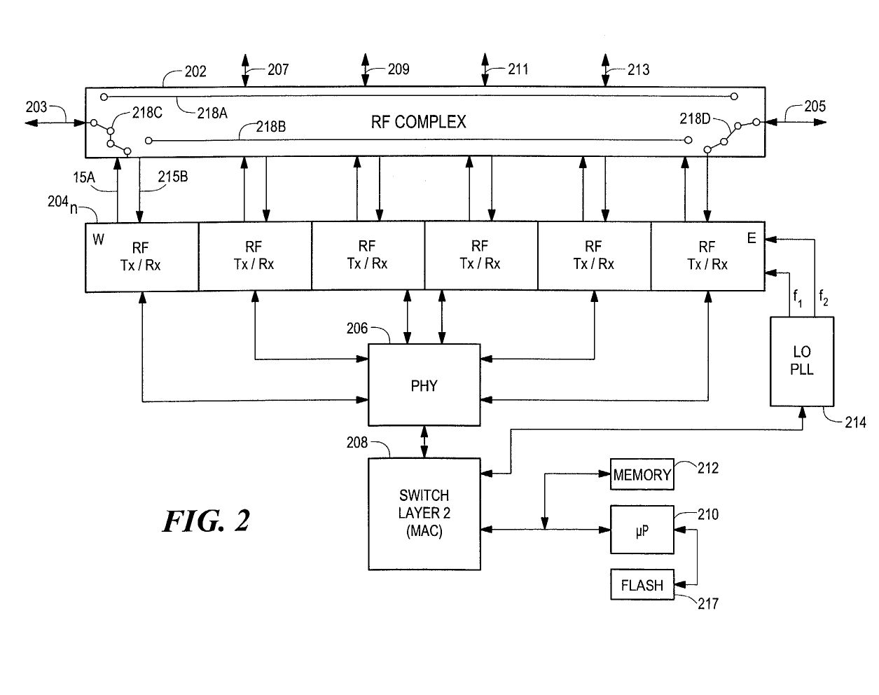

FIG. 2 is a block diagram of an embodiment of any one of the network elements shown in FIG. 1. The network element includes an RF complex 202, RF transmitter/receiver pairs or modems 204a-204n, a PHY (physical layer) device 206, a switch 208, microprocessor 210, memory 212, flash memory 217 and a local oscillator/phase locked loop (LO/PLL) 214. All of the components are common to embodiments of the ODS, DS, SAS and NIU shown in FIG. 1. The ODS further includes an optical/electrical interface. The NIU further includes a 100BaseT physical interface for connecting to the Home LAN 30 (FIG. 2). In addition, the RF complex is shown as having a bypass path 218A and a built in self test path 218B controlled by switches 218C, 218D which are described further herein.

The number of modems, 204n generally, depends on the number of links that connect to the network element. For example, DS 314 (FIG. 1) has five ports and thus has five modems 204. A SAS 316 (FIG. 1) has six ports and thus has six modems 204. The network element in FIG. 2 is shown having six ports indicated as ports 203, 205, 207, 209, 211 and 213.

The PHY device 206 provides physical layer functions between each of the modems 204 and the switch 208. The switch 208, controlled by the microprocessor 210, provides layer 2 switching functions and is referred to herein as the Media Access Control (“MAC”) device or simply MAC. The LO/PLL 214 provides master clock signals to the modems 204 at the channel frequencies.

A modulation system with spectral efficiency of 4 bits/s/Hz is used in the RF modem 604n (FIG. 2) to provide high data rates within the allocated bandwidth. In particular, 16-state Quadrature Amplitude Modulation (16-QAM) is preferably used, which involves the quadrature multiplexing of two 4-level symbol channels. Embodiments of the network elements of the present system described herein support 100 Mb/s and 1 Gb/s Ethernet transfer rates, using the 16-QAM modulation at symbol rates of 31 or 311 MHZ.

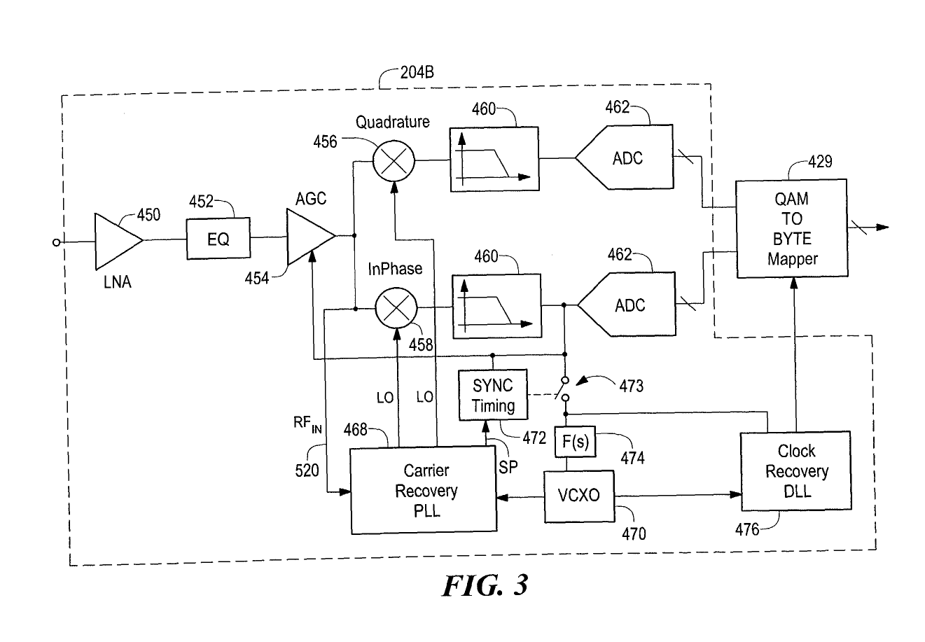

FIG. 3 is a block diagram of a receiver 204B in any of the modems 204 in the network element shown in FIG. 2. The receiver 204B receives a quadrature-multiplexed signal which includes in-phase (I) and quadrature (Q) carriers. At the front end, the receiver section 204B includes low-noise amplifier (LNA) 450, equalizer 452 and automatic gain control (AGC) 454. The received signal from PHY 206 (FIG. 2) is boosted in the LNA 450 and corrected for frequency-dependent line loss in the equalizer 452. The equalized signal is passed through the AGC stage 454 to I and Q multiplier stages 456, 458, low pass filters 460 and analog-to-digital converters (ADC) 462. After down-conversion in the multiplier stages 456, 458 and low-pass filtering, the I and Q channels are digitized and passed on to the QAM-to-byte mapper 429 for conversion to a byte-wide data stream in the PHY device 406 (FIG. 2).

Carrier and clock recovery, for use in synchronization at symbol and frame levels, are performed during periodic training periods. A carrier recovery PLL circuit 468 provides the I and Q carriers from the RF carrier (RFin) 520 to the multipliers 456, 458. The RF carrier 520 includes the I and Q carriers. A clock recovery delay locked loop (DLL) circuit 476 provides a clock to the QAM-to-byte mapper 449. During each training period, PLL and DLL paths that include F(s) block 474 and voltage controlled oscillator (VCXO) 470 are switched in using normally open switch 473 under control of SYNC timing circuit 472 in order to provide updated samples of phase/delay error correction information.

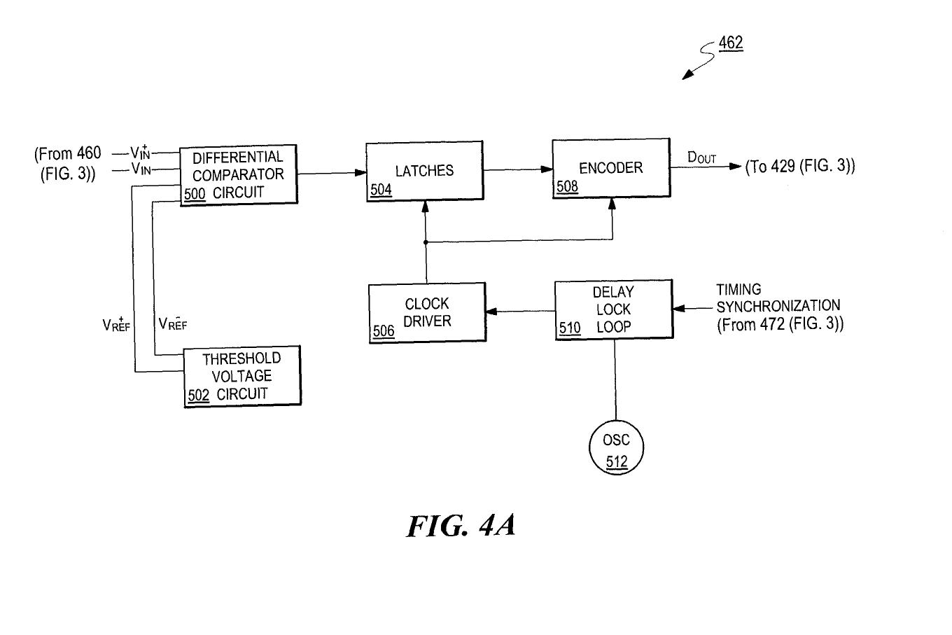

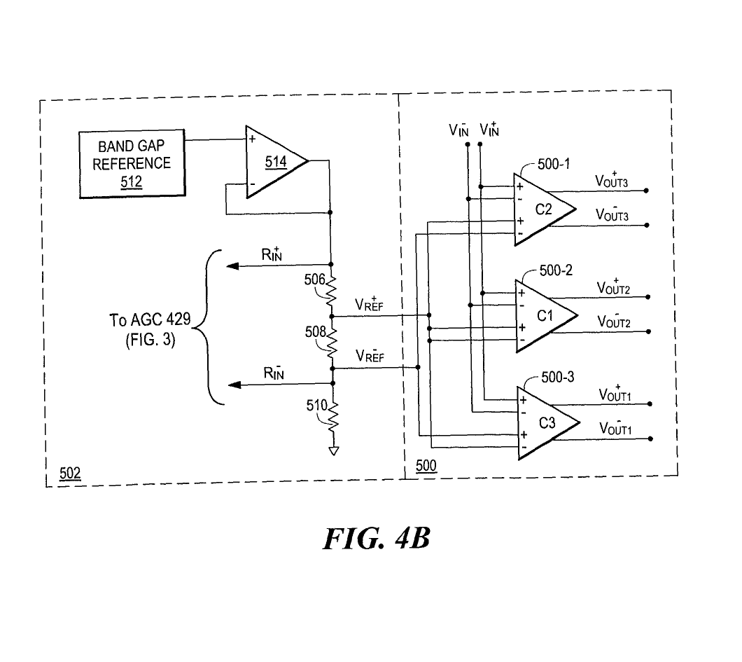

FIG. 4A is a block diagram of a slicer circuit in the ADC 462 shown in FIG. 3 according to the principles of the present invention. The ADC 462 includes a differential comparator circuit 500, a threshold voltage circuit 502, latches 504, a clock driver 506, an encoder 508, a delay lock loop 510 and an oscillator 512.

The differential comparator circuit 500 includes at least one differential comparator for comparing the input signal Vᵢₙ⁺, Vᵢₙ⁻ received from the low pass filter 460 (FIG. 3) with a differential threshold voltage provided by the threshold voltage circuit 502.

The latches 504 are described in co-pending U.S. patent application Attorney Docket No. 3070.1011-000 entitled ‘Slicer Circuit With Ping Pong Scheme for Data Communication” by Dev Gupta, et al., filed on even date herewith, the contents of which are incorporated herein by reference in their entirety.

The result of the comparison in the differential comparator circuit 500 is a thermometer coded output signal which is coupled to latches 504. The thermometer coded signal is latched in the latches dependent on a clock output by the clock driver 506. The clock is dependent on an oscillator 512 synchronized with the input signal Vᵢₙ⁺, Vᵢₙ⁻ by timing synchronization coupled to the delay lock loop 510. The timing synchronization is under control of the sync timing circuit 472 (FIG. 3).

The output of the latches 504 is coupled to the encoder 508. The encoder 508 converts the latched thermometer coded output signal to a binary encoded digital signal which is coupled to the QAM to Byte Mapper 429 (FIG. 3).

FIG. 4B is a circuit diagram of the differential comparator circuit 500 and threshold voltage circuit 502 in the differential slicer circuit shown in FIG. 4A. The differential comparator circuit 500 includes a plurality of differential comparators 500-1, 500-2, 500-3. Each differential comparator 500-1, 500-2, 500-3 includes two cross-coupled matched differential amplifiers. Each differential amplifier has a respective inverting and non-inverting input. The differential comparator outputs a differential output signal dependent on the result of the comparison of the differential input signals coupled to the inputs of the differential amplifiers.

The threshold voltage circuit 502 includes a bandgap reference 512, a buffer 514 and resistors 506, 508, 510. The voltage level of threshold voltages Vref+, Vref− are dependent on the voltage level on the output of buffer 514. Respective different differential threshold voltages are input to each differential comparator 500-1, 500-2, 500-3 by coupling threshold voltages Vref+, Vref− to the non-inverting and inverting inputs of one of the differential amplifiers. For example, if Vref+ is 3.2 Volts and Vref− is 3.0 Volts, a differential threshold voltage of −200 mV is input to a differential amplifier by coupling Vref+ to the inverting input and Vref− to the non-inverting input. A +200 mV differential threshold voltage Vref+, Vref− is input by coupling Vref+ to the non-inverting input and Vref− to the inverting input. A 0V differential threshold voltage is input by coupling Vref+ to both the inverting and non-inverting input.

The threshold voltage circuit 503 also outputs a differential reference voltage Rᵢₙ⁺, Rᵢₙ⁻ for the AGC 454 (FIG. 4). The reference voltage Rᵢₙ⁺, Rᵢₙ⁻ is described in co-pending U.S. patent application Attorney Docket No. 3070.1009-000 entitled “Automatic Gain Control Circuit With Multiple Input Signals”, by Miaochen Wu filed on even date herewith incorporated herein by reference in its entirety.

Differential input signal Vin⁺, Vin⁻ received from the low pass filters 460 (FIG. 3) is coupled to the non-inverting and inverting inputs of the other differential amplifier in each differential comparator. Each differential comparator 500-1, 500-2, 500-3 compares the differential input signal Vin⁺, Vin⁻ with the respective differential threshold voltage. In the embodiment shown, three comparators 500-1, 500-2, 500-3 convert data encoded on the differential input signal Vin⁺, Vin⁻ into a three-bit encoded digital signal, V_{OUT3}⁺, V_{OUT2}⁺, V_{OUT1}⁺ dependent on threshold voltage levels Vref−, Vref+ as shown below in Table 1.

TABLE 1

| | Thermometer Coded Signal | | | | |
|---|---|---|---|---|---|
| Threshold Voltage | Vₒᵤₜ₃⁺ | Vₒᵤₜ₂⁺ | Vₒᵤₜ₁⁺ | D_{OUT} | |
| (Vᵢₙ⁺, Vᵢₙ⁻) < (Vref−, Vref+) | L | L | L | 0 | 0 |
| (Vref⁻, Vref⁺) < (Vᵢₙ⁺, Vᵢₙ⁻)<0 | L | L | H | 0 | 1 |
| (Vref⁺, Vref⁻) > (Vᵢₙ⁺, Vᵢₙ⁻)>0 | L | H | H | 1 | 0 |
| (Vᵢₙ⁺, Vᵢₙ⁻) > (Vref⁻, Vref⁺) | H | H | H | 1 | 1 |

Vₒᵤₜ₃+ is the non-inverting output of differential comparator 500-1. Vₒᵤₜ₂+ is the non-inverting output of differential comparator 500-2. Vₒᵤₜ₁+ is the non-inverting output of differential comparator 500-3.

Returning to FIG. 4A, V_{OUT3}⁺, V_{OUT2}⁺, V_{OUT1}⁺ are latched in the latches 504 by a clock generated by the clock driver. The encoder 508 encodes the 3-bit thermometer code on V_{OUT3}⁺, V_{OUT2}⁺, V_{OUT1}⁻ into a 2-bit digital signal.

Continuing with FIG. 4B and referring to Table 1, in a thermometer code, the number of ‘H’s in the converted signal represents the decimal value. Thus, with three outputs, there are four possible output values dependent on the number of ‘H’s; that is, 0, 1, 2, and 3. The encoder 512 converts LLL to ‘00’, LLH to ‘01’, LHH to ‘10’ and ‘HHH’ to ‘11’ dependent on the number of ‘H’s.

The differential comparator circuit 500 in the embodiment shown in FIG. 4B includes three differential comparators 500-1, 500-2, 500-3. In an alternate embodiment a two level slicer circuit 462 can be provided using one differential comparator to output a thermometer code with two possible output values (L and H). The encoder encodes the two states to a one-bit digital output with two states; 0 and 1.

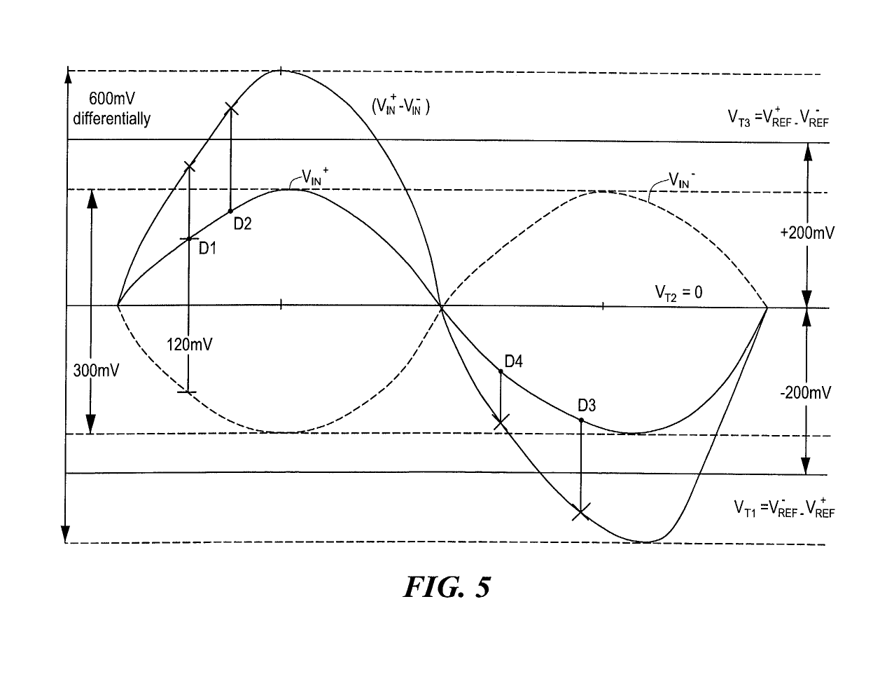

FIG. 5 illustrates an example of a differential input signal Vin+, Vin− that is input to each of the differential comparators 500-1, 500-2, 500-3 in the differential comparator circuit 502 shown in FIG. 4B. The differential input signal Vin+, Vin− has been amplified by the AGC 454 (FIG. 3) to output a 300 mV peak to peak differential signal, or 600 mV peak to peak differentially. The differential input signal Vin+, Vin− is converted to a thermometer encoded signal by the differential comparator circuit 502 by comparing the differential input signal Vᵢₙ⁺, Vᵢₙ⁻ with a respective differential threshold in each differential comparator 500-1, 500-2, 500-3. The threshold voltages are coupled to non-inverting and inverting inputs of the differential comparators to provide differential threshold signals. The differential input signal Vᵢₙ⁺, Vᵢₙ⁻ is compared with differential threshold voltages in the differential comparator to minimize the effect of different common mode voltages between the threshold voltages and the differential input signal Vᵢₙ⁺, Vᵢₙ⁻.

The threshold differential signals input to the differential comparators 500-1, 500-2, 500-3 are represented by V_{T3}, V_{T2}, and V_{T1}. Returning to FIG. 4B, V_{T3} corresponds to the differential threshold input to differential comparator 500-1 by coupling Vref+ to the non-inverting input and Vref− to the inverting input. V_{T2} corresponds to the differential threshold input to differential comparator 500-2 by coupling Vref+ to both the non-inverting input and the inverting input. V_{T1} corresponds to the differential threshold input to differential comparator 500-3 by coupling Vref+ to the inverting input and Vref− to the non-inverting input.

In an embodiment in which Vref+ is 3.2 Volts (mV) and Vref− is 3.0 V, the differential threshold voltage coupled to differential comparator 500-1 is 200 mV, the differential threshold voltage coupled to differential comparator 500-3 is −200 mV and the differential threshold voltage coupled to differential comparator 500-2 is 0 V. The differential input signal Vin+, Vin− for each encoded data D1, D2, D3, D4 (FIG. 5) on the differential input signal Vᵢₙ⁺, Vᵢₙ⁻ is compared in each of the differential comparators 500-1, 500-2, 500-3 with a respective one of the differential threshold voltages V_{T3}, V_{T2}, and V_{T1} to output the respective differential encoded digital signal Vₒᵤₜ₃+, Vₒᵤₜ₃−, Vₒᵤₜ₂+, Vₒᵤₜ₂_{⁻}, Vₒᵤₜ₁+, Vₒᵤₜ₁_{⁻}. The encoded data D1, D2, D3, D4 is converted to a thermometer coded signal as shown below in Table 2.

TABLE 2

| | Thermometer Coded Signal | | |
|---|---|---|---|
| Data (Vᵢₙ⁺, Vᵢₙ⁻) | Vₒᵤₜ₃+ | Vₒᵤₜ₂+ | Vₒᵤₜ₁+ |
| D1 | L | H | H |
| D2 | H | H | H |
| D3 | L | L | L |
| D4 | L | L | H |

For example, as shown in FIG. 5, the differential input signal Vin+, Vin− for data D1 is 120 mV. Returning to FIG. 4B, in comparator 500-1, the 120 mV differential input signal Vin+, Vin− is compared with the 200 mV differential threshold voltage. A ‘L’ level voltage is output on the non-inverting output because the differential input signal is less than the differential threshold voltage. In comparator 500-2, the 120 mV differential input signal on Vin+, Vin− is compared with the 0 V differential threshold voltage. A ‘H’ level voltage is output on the non-inverting output because the differential input signal is greater than the differential threshold voltage. In comparator 500-3, the 120 mV differential input signal on Vin+, Vin− is compared with the −200 mV differential threshold voltage. A ‘H’ level voltage is output on the non-inverting output because the differential input signal is greater than the differential threshold voltage.

The differential input voltages for D2, D3 and D4 are also compared with each of the differential threshold voltages as described above for D1 in differential comparators 500-1, 500-2, 500-3. The differential input voltage for D2 is greater than all of the differential threshold voltages resulting in a ‘H’ level voltage on the non-inverting output of each of the differential comparators 500-1, 500-2, 500-3. The differential input voltage for D3 is less than each of the differential threshold voltages resulting in a ‘L’ level voltage on the non-inverting output of each of the differential comparators 500-1, 500-2, 500-3. The differential input voltage for D4 is greater than the −100 mV differential reference voltage and less than the other differential reference voltages resulting in a ‘H’ level voltage on the non-inverting output of differential comparator 500-1 and a ‘L’ level voltage on the non-inverting output of differential comparators 500-2 and 500-3.

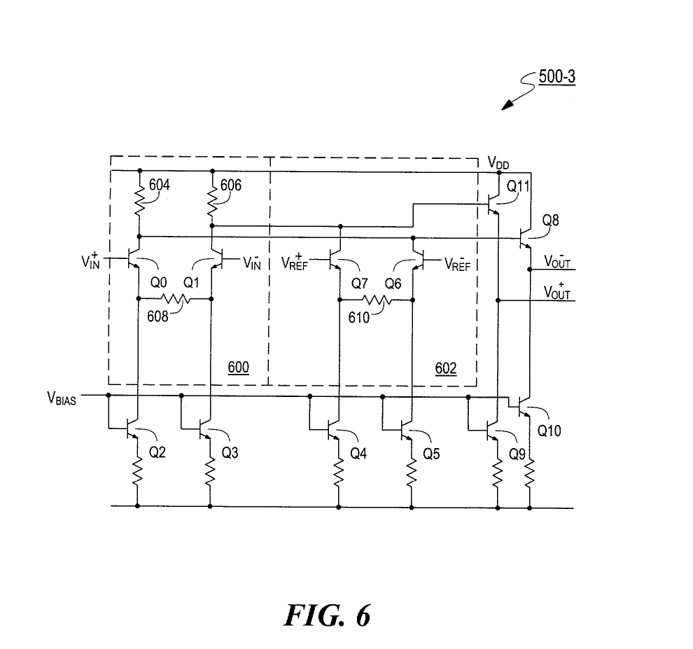

FIG. 6 is a circuit diagram of any one of the differential comparators 500-1, 500-2, 500-3 in the slicer circuit 502 shown in FIG. 4. The differential comparator includes two differential amplifiers 600, 602. Differential amplifier 600 includes transistors Q0 and Q1. Differential amplifier 602 includes transistors Q6 and Q7. The differential amplifiers 600, 602 are cross-coupled by coupling the collector of transistor Q0 in amplifier 600 to the collector of transistor Q6 in amplifier 602 and coupling the collector of transistor Q1 in differential amplifier 600 to the collector of Q7 in differential amplifier 602.

Cross-coupling the differential amplifiers 600, 602 results in a differential comparator 502 that compares only differential voltages. By comparing only the differential voltages, the effects of mismatched components in the differential amplifiers on the common mode voltage is minimized if the differential amplifiers 600, 602 have good Common Mode Rejection (CMRR).

The transistors Q0, Q1, Q7 and Q6 are bipolar transistors biased to operate with a small signal within a linear range. In the linear range, the collector current increases linearly with an increase in the voltage at the base of the transistor. A degeneration resistor 608 is coupled between the emitters of transistors Q0 and Q1 in differential amplifier 600 and a degeneration resistor 610 is coupled between the emitters of transistors Q7 and Q6. The degeneration resistors 608, 610 increase the input voltage range within which the transistors act linearly. The linear region is increased because the input voltage at the base of the transistors is dropped across both the base-emitter junction and the degeneration resistor rather than all of the input voltage being dropped only across the base-emitter junction.

When operating in the linear region of transistor operation, the collector current is linearly related to the voltage at the base of the transistor. The transistor is fully turned on if the collector current has reached the saturation point; that is, the point where further increases of input voltage do not result in an increase in the collector current. In the linear region, the size of the collector current determines whether the transistor is weakly turned on or strongly turned on.

The differential comparator 500-3 also includes two emitter followers Q11, Q8. Each emitter follower acts as a buffer. The non-inverting output Vout+ and inverting output Vout− of the differential comparator are coupled to a respective emitter follower Q11, Q8. Both emitter followers are always ‘on’. The differential voltage between the non-inverting output Vout+ and inverting output Vout− is dependent on the result of the comparison of the differential input signal and the respective differential threshold voltage.

Encoded data D1 shown in FIG. 5 is converted to a three bit digital code in the comparators 500-1, 500-2, 500-3 as shown in Table 3 below:

TABLE 3

| (Vin+ - | | | | | | |
|---|---|---|---|---|---|---|
| Vin−) | (Vref+ - Vref−) | Q7/Q6 | Q0/Q1 | Q11 | Vout+ | Vout− |
| +120 mV | +200 mV | s/w | s/w | on | L | H |
| +120 mV | 0 | on/on | s/w | on | H | L |
| +120 mV | −200 mV | w/s | s/w | on | H | L |

The terms strongly on (‘s’) and weakly on (‘w’) refer to the size of the collector current dependent on the voltage at the base of the transistor while operating in the linear region of the transistor. Thus, a transistor is considered ‘strongly on’, ‘weakly on’ or ‘on’ dependent on the voltage level at the base of the transistor. With transistor Q0 strongly on, a large collector current flows through resistor 604. With transistor Q6 strongly on, a portion of the collector current flowing through resistor 604 flows through transistor Q6. Mathematically, the differential output signal V⁺_{OUT}, V⁻_{OUT} is the result of subtracting the differential threshold signal V_{ref}⁺, V_{ref}⁻ from the differential input signal Vᵢₙ⁺, Vᵢₙ⁻. When the differential output signal is greater than 0, the V_{OUT}⁺ signal is ‘H’. Otherwise it is ‘L’. With both emitter followers Q11, Q8 always ‘on’ and output voltage V_{OUT}⁻, V_{OUT}⁺ dependent on the collector current flowing through transistors Q0, Q1, Q6 and Q7 the differential voltage on V_{OUT}⁻, V_{OUT}⁺ is large. For example, the respective output V_{OUT}⁺, V_{OUT}⁻ is ‘H’ if the voltage level on V_{OUT}⁺ is greater than or equal to 4.3V and ‘L’ if the voltage level on V_{OUT}⁺ is less than or equal to 3.5V with a differential output voltage V_{OUT}⁺, V_{OUT}⁻ of 0.8V.

Transistors Q0 and Q7 are strongly on and transistors Q1 and Q6 are weakly on with a differential voltage of 120 mV applied between the base of transistor Q0 and the base of transistor Q1 and a differential voltage of 200 mV applied between the base of transistors Q7 and Q6. Thus, the collector current from transistor Q6 is added to with the collector current for transistor Q0 to make the current for resistor 604. With transistor Q1 weakly on, a large collector current flows through resistor Q0. With transistor Q7 strongly on, a small portion of the collector current flows through transistor Q6. Transistor Q11 and transistor Q8 are always on. The voltage level at the base of transistors Q11 and Q8 is dependent on the collector current flowing through resistors 604 and 606. Thus, with more current flowing through resistor 604 than resistor 606, the voltage at the base of transistor Q11 is higher than that at the base of transistor Q8 resulting in a positive differential voltage on Vout⁺, Vout⁻ and a ‘H’ voltage level on the Vout⁺ signal coupled to the emitter of Q11. As shown in Table 3, the non-inverting differential output V_{OUT}⁺ is ‘H’ when the differential input is greater than the differential threshold.

Transistors Q2, Q3 act as a current source for differential amplifier 600 by providing a bias current. Transistors Q4, Q5 act as a current source for differential amplifier 602 by providing a bias current. Transistor Q9 provides a bias current for emitter follower Q11 and transistor Q10 provides a bias current for emitter follower Q10.

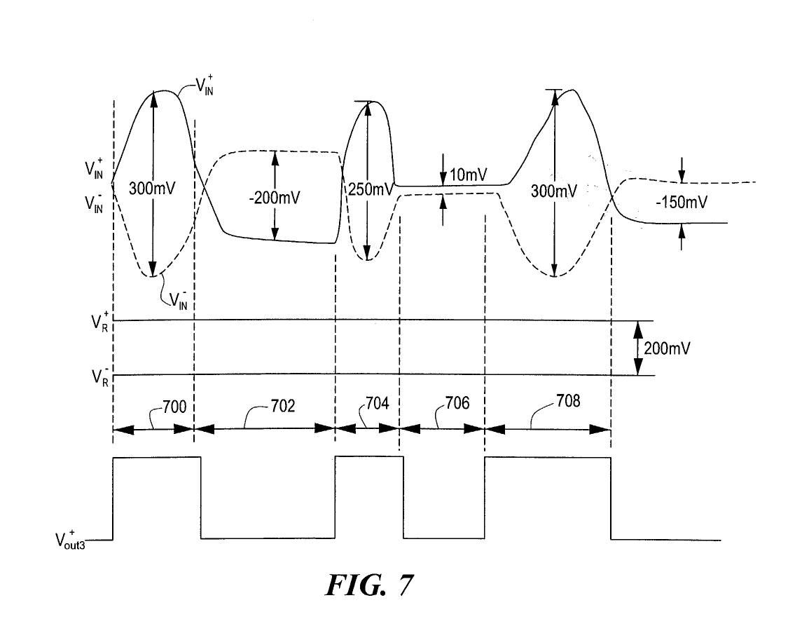

FIG. 7 is a timing diagram illustrating signals in comparator 500-1 shown in FIG. 4. The differential reference voltage is a positive 200 mV differential voltage. The differential input voltage ranges from 300 mV to 10 mV peak to peak. During time period 700, the differential input voltage is 300 mV, the 200 mV differential reference voltage is subtracted from the 300 mV differential input voltage outputting a ‘H’ voltage level on the non-inverting differential output Vout3⁺. Similarly, during time periods 704 and 708, a “H” voltage level is output on the non-inverting differential output Vout3 after subtracting the 200 mV differential reference voltage from the differential input.

During time period 702, the differential input voltage is −200 mV, the 200 mV differential reference voltage is subtracted from the −200 mV differential input signal to output a ‘L’ voltage level on the non-inverting differential output Vout3⁺. Similarly, during time period 706, there is a ‘L’ voltage level on the non-inverting differential output Vout3⁺ after subtracting the differential reference voltage from the differential input. Thus, the comparator outputs a ‘L’ voltage level on the non-inverting differential output when the differential input voltage is greater than the differential threshold voltage.

While this invention has been particularly shown and described with references to preferred embodiments thereof, it will be understood by those skilled in the art that various changes in form and details may be made therein without departing from the scope of the invention encompassed by the appended claims.

What is claimed is:

1. A slicer circuit in a receiver comprising:
a threshold voltage circuit generating a plurality of differential threshold signals; and
a differential comparator, the differential comparator including a first differential amplifier and a second differential amplifier, the first and second differential amplifiers cross-coupled to output a differential output signal dependent on a difference between one of the differential threshold signals coupled to the first differential amplifier and a differential input signal coupled to the second differential amplifier.

2. The slicer circuit as claimed in claim 1 further comprising:
a plurality of differential comparators.

3. The slicer circuit as claimed in claim 1 wherein a non-inverting input of the first differential amplifier is coupled to a first transistor and an inverting input of the first differential amplifier is coupled to a second transistor, a non-inverting input of the second amplifier is coupled to a third transistor and an inverting input of the second differential amplifier is coupled to a fourth transistor, the first and second differential amplifiers being cross-coupled by coupling the collector of the first transistor to the collector of the third transistor and coupling the collector of the second transistor to the collector of the fourth transistor.

4. The slicer circuit as claimed in claim 1 further comprising:
a first emitter follower coupled to the first differential amplifier; and
a second emitter follower coupled to the second differential amplifier, the differential output coupled between the first emitter follower and the second emitter follower.

5. The slicer circuit as claimed in claim 2 wherein the transistors are bi-polar and operate in a linear region.

6. The slicer circuit an claimed in claim 1 wherein the differential input signal is 600 milli Volts peak to peak differentially and the differential threshold signals are 200 mili Volts, −200 milli Volts and 0 Volts.

7. The slicer circuit as claimed in claim 2 wherein the number of differential comparators is three.

8. A method for recovering data encoded in a received signal comprising:
generating a plurality of differential threshold signals;
coupling one of the differential threshold signals to inputs of a first differential amplifier;
coupling a differential input signal to inputs of a second differential amplifier, the second differential amplifier cross-coupled to the first differential amplifier; and
outputting a differential output signal dependent on the difference between the differential threshold signal and the differential input signal.

9. The method as claimed in claim 8 wherein the first and second differential amplifiers are cross-coupled by coupling the collector of a first transistor to the collector of a third transistor and the collector of a second transistor to the collector of a fourth transistor, coupling a non-inverting input of the first differential amplifier to the first transistor and coupling an inverting input of the first differential amplifier to the second transistor and coupling non-inverting input of the second amplifier to the third transistor and coupling an inverting input of the second differential amplifier to the fourth transistor.

10. The method as claimed in claim 8 further comprising:
coupling a first emitter follower to the first differential amplifier and a second emitter follower to the second differential amplifier, the differential output signal coupled between the first emitter follower and the second emitter follower.

11. The method as claimed in claim 9 wherein the transistors are bi-polar and operate in a linear region.

12. The method as claimed in claim 8 wherein the differential input signal is 600 milli Volts peak to peak differentially and the differential threshold signals are 200 mili Volts, −200 milli Volts and 0 Volts.

13. A slicer circuit comprising:
means for generating a plurality of differential threshold signals; and
means for outputting a differential output signal dependent on the difference between one of the differential threshold signals and a differential input signal by coupling the differential threshold signal to inputs of a first differential amplifier and coupling the differential input signal to inputs of a second differential amplifier, the second differential amplifier cross-coupled to the first differential amplifier.

14. The slicer circuit as claimed in claim 13 wherein a non-inverting input of the first differential amplifier is coupled to a first transistor and an inverting input of the first differential amplifier is coupled to a second transistor, a non-inverting input of the second amplifier is coupled to a third transistor and an inverting input of the second differential amplifier is coupled to a fourth transistor, the first and second differential amplifiers cross-coupled by coupling the collector of the first transistor to the collector of the third transistor and the collector of the second transistor to the collector of the fourth transistor.

15. The slicer circuit as claimed in claim 13 further comprising:
a first emitter follower coupled to the first differential amplifier and a second emitter follower coupled to the second differential amplifier, the differential output signal coupled between the first emitter follower and the second emitter follower.

16. The slicer circuit as claimed in claim 15 wherein the transistors are bi-polar and operate in a linear region.

17. The slicer circuit as claimed in claim 13 wherein the differential input signal is 600 milli Volts peak to peak differentially and the differential threshold signals are 200 milli Volts, −200 milli Volts and 0 Volts.
